(19) United States
(12) Patent Application Publication
(10) Pub. No.: US 2007/0151150 A1
(43) Pub. Date: Jul. 5, 2007

(54) Portable garden box with protective fence

(76) Inventor: Martiniano Rupert Sandoval, Phoenix, AZ (US)

Correspondence Address: CHRISTOPHER D. HARRINGTON, SUITE 350, 5300 CORPORATE GROVE DRIVE SE, GRAND RAPIDS, MI, 49512, US

(21) Appl. No.: 11/323,836

(22) Filed: Jan. 3, 2006

(51) Int. Cl. A01G 9/02

(52) U.S. Cl. 47/66.1

(57) ABSTRACT

A novel portable garden box for use in growing plants, comprises a fence and a tub, where the fence is attached to fence posts that are insertable into the tub. The tub includes a tub lip, four walls, a bottom, postholes for receiving the fence posts and drain holes for providing drainage. The tub is fillable with soil under conditions that provide a suitable growing environment. The garden box, when fully assembled with the fence installed on the tub, provides barrier protection from small animals and the like. The garden box of the present invention is preferably constructed with a substantially square tub that is optimizeable for shipping and packaging purposes and for alignment of the garden boxes in various arrays by the end user.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to a portable garden box for use in growing vegetables or other plants. More specifically, the present invention relates to a portable garden box that allows for the growing of plants in selected spaces while providing a protective barrier against foraging animals.

Portable garden boxes or portable garden beds have been known in the prior art and have become even more popular today. Gardening is a pastime that many people and it knows no age barriers and is accessible to those with physical limitations of many kinds. The technology behind gardening is something that can spark a rabid discussion among aficionados and can readily inform the casual observer that this is a mainstream activity that even though it is well practiced, it remains fraught with specific problems and issues that arise even with the most modest of undertakings.

One problem that has arisen and which has been observed by the applicant is the need for a portable garden that provides protection for the plants that are grown. Even in urban environments, there are pests that can invade a garden bed and devastate the plants. These include small animals such as cats or mice, and can include larger insects such as moths. In addition, there are other so-called pests, notably humans, who can also present problems with the garden box. Small children, for instance, invariably find the garden box an attraction that needs to be explored, and unfortunately, this often leads to tragedy when the plants are damaged or destroyed. The problem can also arise from adults who either don't recognize the existence of the garden box or believe it to serve as an ashtray or waste receptacle and may be prone to bump it or worse.

There have been garden box inventions in the prior art that have taken many different approaches to portable gardening. For instance, U.S. Pat. No. 3,118,249 (Bard, et al) teaches the use of a stackable tray for growing mushrooms. Multiple stacking trays can be used for mushroom farming since direct sunlight is not necessary for the propagation of mushrooms, unlike vegetables or flowers. The short wall in this concept would provide only nominal protection against the hazards that are known to occur with respect to gardening in portable beds or boxes.

In U.S. Pat. No. 6,681,522 B2 (Marchioro) a modular gardening system is disclosed that utilizes standardized wall and post construction to allow substantial gardening units to be installed in buildings, or lobbies, or arenas, and the like. The invention also includes trellises for climbing plants. This invention is not as truly as portable as that envisioned by the applicant herein and it does not provide the functionality for setting up discrete garden boxes with protective fences.

The use of fencing for assisting in the cultivation of climbing plants is shown in U.S. Pat. No. 5,752,341 (Goldfarb) which displays a free-standing trellis that can be used in conjunction with portable garden boxes. This invention does not teach the protective fencing of the present invention, however, nor does it provide an integrated device for the growing of plants in select growing environments.

Other inventions that are known also provide containment for plants of various types such as, U.S. Pat. No. 6,134,834 (Ripley, Sr., et al) plant container with modules for growing differing types of plants; U.S. Design Patent D402,229 (Christensen) a design for a knock-down planter box; U.S. Pat. No. 1,129,554 (Courtney) planter box with subirrigation; and U.S. Pat. No. 2,814,427 (Emery) a molded pulp plant container. None of these reveal a portable garden box that has integrated protection for pests and others, or that can be used as easily as the present invention in selected growing environments. These and other attributes and features of the present invention will be disclosed in more detail below.

### SUMMARY OF THE INVENTION

A novel portable garden box comprises a tub with formed fence postholes which are engageable by fence posts that are affixed to fencing that is vertically oriented above the tub lip and about the periphery of the tub. The fencing, fence posts and tub form an integrated gardening unit that is competent to receive soil within the tub and which is suitable for growing plants. The tub may also contain drain holes allowing for the drainage of percolated water from the soil.

The portable garden box of the present invention may be supplied to end users in the form of a kit with the fencing and the posts affixed appropriately and with the combination sized for immediate assembly.

### BRIEF DESCRIPTION OF THE DRAWINGS

FIG. 1 is a front isometric view of the garden box of the present invention with the fencing installed on the fence posts and the fence posts installed into their corresponding fence postholes in the tub.

FIG. 2 is another front isometric view of the garden box of FIG. 1, with the fencing shown in an orientation above its installation alignment on the tub, in a condition that is transitioning towards installation or towards removal of the fencing from the tub.

FIG. 3 is a side cross-sectional view of the garden box of FIG. 1 taken at Section 3-3.

FIG. 4 is a side cross-sectional view of the garden box of FIG. 1 taken at Section 4-4.

### DETAILED DESCRIPTION OF THE PREFERRED EMBODIMENT

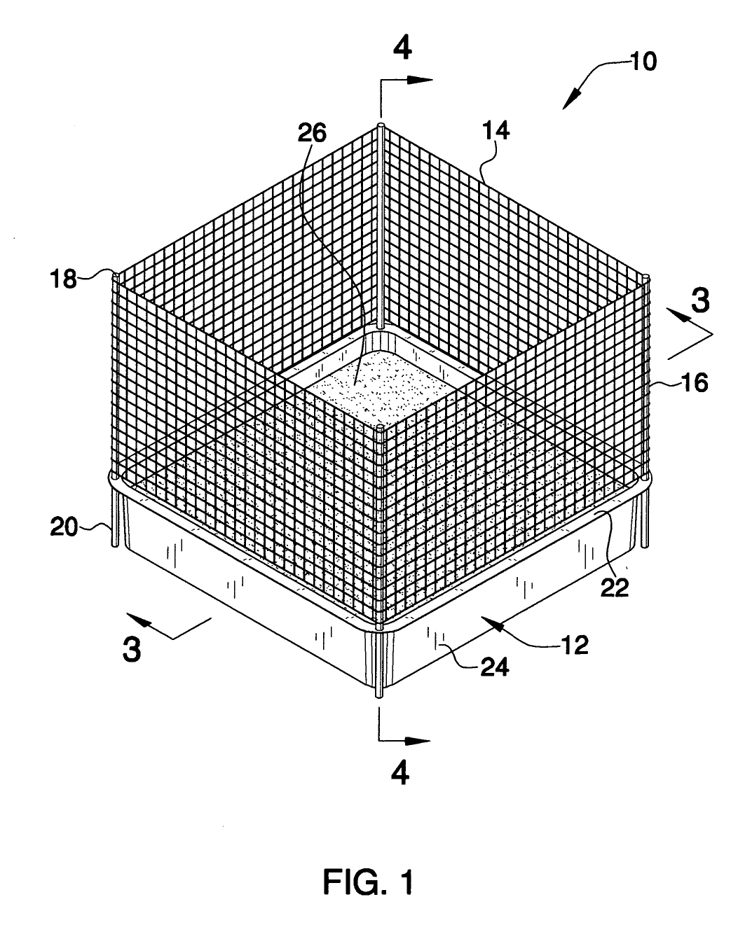

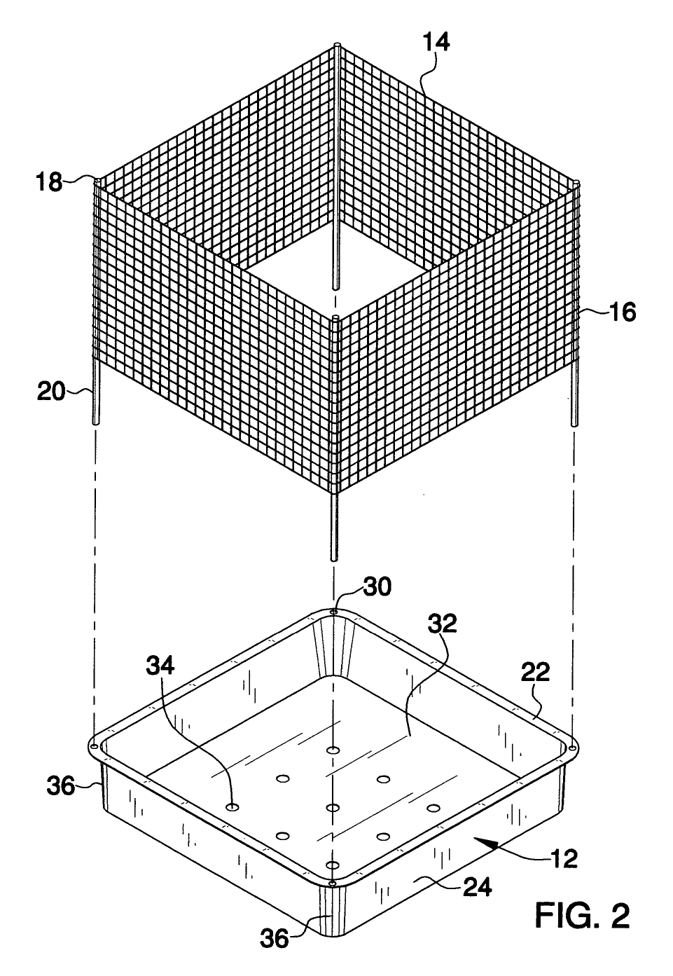

A new garden box in accordance with the present invention is shown in FIGS. 1 and 2, with the garden box 10 comprising the tub 12 and the fence 14. The fence 14 further includes the fence post(s) 16 with the fence post top(s) 18 and the fence post bottom(s) 20. The tub 12 includes the tub lip 22, the tub wall(s) 24, the post hole(s) 30, the tub bottom 32, the drain holes 34 and the tub corner(s) 36. The soil 26 is shown in FIG. 1 as partially filling the tub 12.

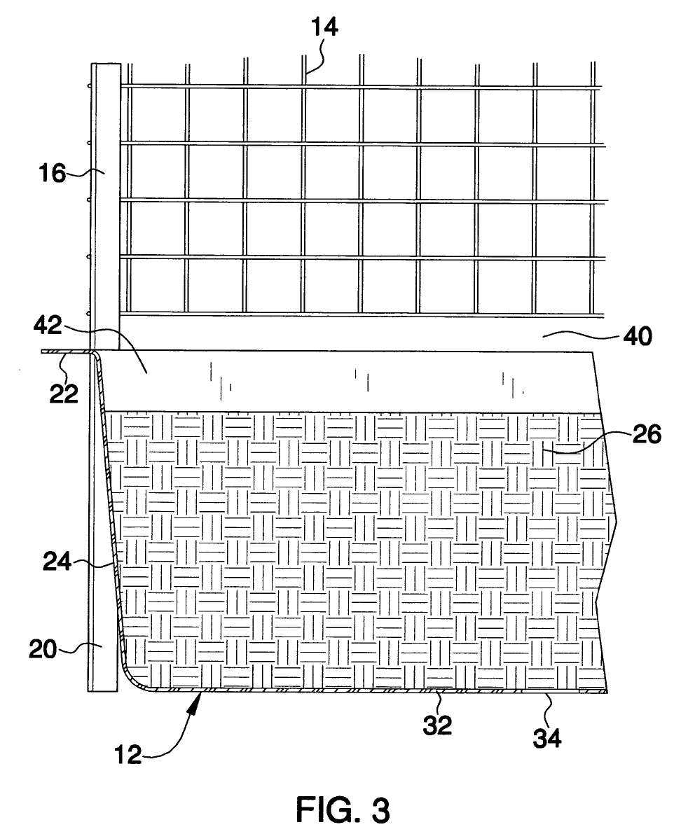

Turning to FIG. 3, the gap 40, which is the space between the bottom of the fence 14 and the tub lip 22 is shown as is the freeboard 42 which is the space above the top level of the soil 26 and the tub lip 22.

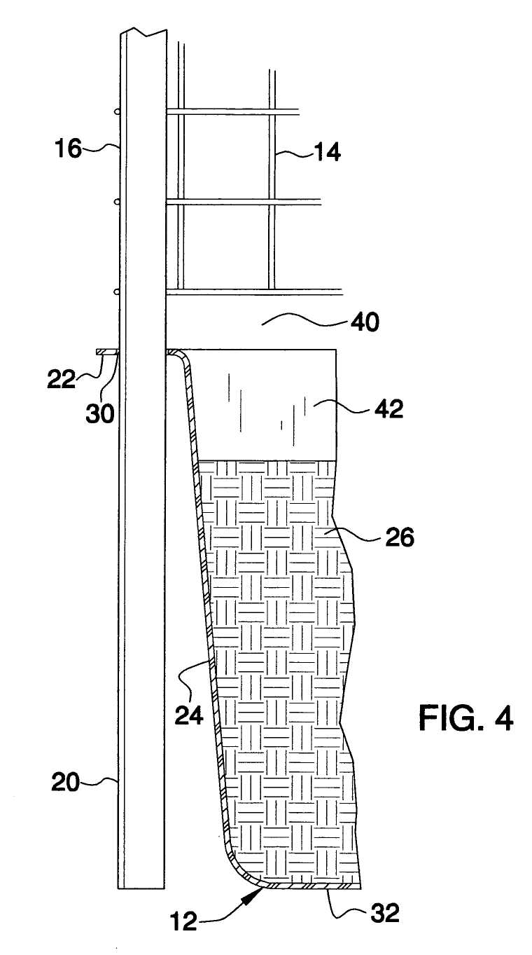

The representation of the present invention in FIG. 4 shows the same features as above as a cross section taken in the area of one of the tub corners 36.

The use of the portable garden box 10 of the present invention is perhaps best explained in FIG. 2. In particular, the fence 14 and the fence posts 16 may preferably be pre-assembled when the garden box 10 is supplied in kit form. The fence posts 16 are affixed to the fence 14 by any conventional means, including but not limited to stapling, nailing with brads and the like, or even with glue. The fence 14 itself may be fabricated from a number of different materials, all of which are suited for the purposes intended, including but not limited to so-called chicken wire, wire mesh, fabric mesh or plastic mesh. The qualifying provision is that the fence material has to sufficiently provide barrier protection from the anticipated threat which can come from insects, various animals, as well as children and careless adults. Generally speaking, the preferred material for fence fabrication is a wire mesh similar to chicken wire construction. The fence 14 when made up of materials such as wire has the advantage of retaining a “memory” so that it can be formed to follow the shape of the tub 12. This aspect of the fence 14 helps to increase the stability of the fence 14 assembly.

As seen in FIG. 2, the fence 14 and fence post 16 assembly is generally positioned above the tub 12 for installation. Each of the four fence posts 16 are aligned with a corresponding posthole 30 located on the tub lip 22 and typically located at each tub corner 36. The assembly is fitted into the postholes 30 and as shown in FIG. 1, with the fence post bottom 20 extending through the posthole 30 and end up sitting on the same surface as the tub bottom 32. There is preferred a tight fit between the fence post 16 and the posthole 30 to encourage stability in the fence 14. The completed garden box 10 that results is freestanding and competent to protect the plants that will be growing in the tub 12. The fence post(s) 16 are typically fabricated from wood stock although they could be fabricated from plastic stock as well. Wood construction is especially useful when staples or brads are used to affix the fence 12 to the fence post(s) 16.

Turning now to the tub 12 construction, the tub 12 is typically fabricated from a plastic resin, and preferentially it is the result of a plastic injection molding process. The tub 12 could be fabricated from fiberglass as well, and it could also be fabricated from steel or other metal. These materials are typically more costly to work with and the plastic construction has the advantage of simultaneous formation of the various tub features such as the tub lip 22, the postholes 30 and the drain holes 34 when the tub is injection molded.

The tub 12 sizing and shape is of consideration in the present invention. The preferred embodiment is square since this shape provides for economical packing for shipment since they can be stacked inside each other and can be placed square on skids. A round shape can also be used for shipping and packaging purposes and would, like the substantially square embodiment, be compatible with stacking although it would consume a larger footprint per square foot of useable growing space as compared to the square shape. The square shape also provides maximal square footage for the growing space. The garden boxes 10 of the present invention if arrayed as square units, can be placed in groupings that make the best use of limited floor space on decks or porches. The array of garden boxes 10 also allows for arrangements for rows or other patterns that are symmetrically suited for square shaped construction. In the alternate, round tubs 12 can be used instead without departing from the spirit of the present invention, where the postholes 30 would be distributed equidistant around the diameter of the tub lip 22 in such an embodiment.

As may be inferred from FIG. 1, soil 26 is provided to fill the tub 12 to a useable level for growing plants. The type of plants grown are certainly at the discretion of the user, although many times it is anticipated that the present invention will provide excellent service for vegetables. In particular, the use of garden boxes 10 has been stymied by actual observation of the applicant for the reason that they seem very vulnerable to squirrels, rodents and other small animals of this ilk. The usage of the present invention has solved this problem very handily and vegetables can be grown with much success than was previously the case. Thus the growing environment best suited for vegetables is often considered which means a sufficient depth of rich soil, that is drained sufficiently. In the case of the preferred embodiment, the square tub 12 works very well when it is sized approximately four and one-half feet wide and with tub walls 24 that are approximately twelve inches deep. This would provide an ample environment for the plants and remains a size that can still be handled easily by the consumer.

The fence 14 for the garden box 10 is preferably high enough to thwart the small animals that might seek the plants, and it should also be high enough to gain the attention of adults who might otherwise trip over the garden box 10. In use, a fence 14 of approximate height of three feet has been shown to be effective. The fence materials, the fence 14 and the fence posts 16, can be prepared and assembled in advance for the convenience of the user. The fence 12, as indicated above, is approximately three feet in height, while the fence posts 16 are longer by approximately twelve inches. In any event, the fence 14 and the fence posts 16 can be stowed diagonally within the preferred embodiment of the present invention, allowing them to be packaged as kits that include all necessary components (excepting for the soil 26) in one unit. It is also noted that the fence posts 16 do not necessarily have to fit into postholes 30 that are located exclusively at the tub corners 36. In some cases it may be preferred to have more postholes 30 that just the four contemplated, which could result in postholes 30 distributed about the tub lip 22 at select locations. If additional fence stability is needed, the inclusion of additional postholes 30 would be of benefit.

It is noted that a gap 40 is typically realized between the bottom of the fence 14 and the top of the tub lip 22. This gap 40 can be calculated to be roughly equal to the sizes of the holes in the fence 14 itself thus maintaining consistent barrier protection. The gap 40 ensures that the fence 14 will not bottom out on the tub lip 22 which could render the fence 14 unstable. Similarly, there is some freeboard 42 indicated between the top of the soil 26 and the tub lip 22. This is the natural method for supplying a growing environment and it prevents overflows when watering the plants as well as the inadvertent loss of soils if the level were topped off at the tub lip 22.

The use of the present invention is intended to increase the enjoyment of those who have an affinity for gardening, whether this is for the purposes of growing vegetables or flowers, and who may otherwise lack sufficient land. The usage of the garden box 10 allows gardening to take place on porches or decks or other spaces in and around the home. In addition, the garden box 10 may also be used in other settings such as commercial or retail areas as a means for decoration or to provide a pleasing diversion.

The features and attributes illustrated herein are meant to disclose the invention and are not intended to operate as limitations or to limit the scope of the invention in any way.

I claim:

1. A portable garden box for use in growing plants, the garden box comprising:
A fence for providing barrier protection, said fence being affixed to a plurality of fence posts with extending fence post bottoms; and,
A tub for holding soil, the tub including four walls, a bottom, drain holes, and a tub lip with spaced postholes for receiving said fence post bottoms.

2. The portable garden box of claim Number 1, where the tub is fabricated from an injected molded plastic.

3. The portable garden box of claim Number 1, where the fence is comprised of a wire construction.

4. The portable garden box of claim Number 1, where the garden box is comprised of a substantially square tub.

5. The portable garden box of claim Number 1, where the unassembled garden box is stackable.

6. A portable garden box for use in growing plants, the garden box comprising:
A fence for providing barrier protection, said fence being affixed to a plurality of fence posts with extending fence post bottoms;
A tub for holding soil, the tub including four walls, a bottom, drain holes, and a tub lip with spaced postholes for receiving said fence post bottoms, where said tub is fabricated from an injected molded plastic; and,
Where the unassembled garden box is stackable.

7. The portable garden box of claim Number 6, where the portable garden box is comprised of walls of equal length forming a substantially square tub with four corners.

8. The portable garden box of claim Number 6, where the fence is comprised of a wire construction.

9. The portable garden box of claim Number 6, where the fence is comprised of a wire mesh.

10. The portable garden box of claim Number 7, where the postholes are located substantially at the corners of the tub.

11. The portable garden box of claim Number 7, where each of said walls is approximately four and one-half feet in length and the tub is approximately twelve inches in depth.

12. A portable garden box for use in growing plants, the garden box comprising:
A fence for providing barrier protection, said fence being affixed to a plurality of fence posts with extending fence post bottoms;
A tub for holding soil, the tub including four walls, a bottom, drain holes, and a tub lip with spaced postholes for receiving said fence post bottoms, where said tub is fabricated from an injected molded plastic and where said walls are of equal length forming a substantially square tub with four corners; and,
Where the unassembled garden box is stackable.

13. The portable garden box of claim Number 12, where the postholes are located substantially at the corners of the tub.

14. The portable garden box of claim Number 12, where the fence is comprised of a wire construction.

15. The portable garden box of claim Number 12, where each of said walls is approximately four and one-half feet in length and the tub is approximately twelve inches in depth.

16. The portable garden box of claim Number 12, where the fence is comprised of a wire mesh.

17. The portable garden box of claim Number 12, where each of said walls is approximately four and one-half feet in length and the tub is approximately twelve inches in depth.
